(19) United States
(12) Patent Application Publication
(10) Pub. No.: US 2026/0204797 A1
(43) Pub. Date: Jul. 16, 2026

(54) RADIO WAVE CONTROL ELEMENT

(71) Applicant: FUJIFILM Corporation, Tokyo (JP)

(72) Inventors: Taketo OTANI, Minamiashigara-shi (JP); Yukito SAITOH, Minamiashigara-shi (JP); Ryoji GOTO, Minamiashigara-shi (JP); Hideki YASUDA, Minamiashigara-shi (JP)

(73) Assignee: FUJIFILM Corporation, Tokyo (JP)

(21) Appl. No.: 19/562,861

(22) Filed: Mar. 11, 2026

Related U.S. Application Data
(63) Continuation of application No. PCT/JP2024/033570, filed on Sep. 20, 2024.

(30) Foreign Application Priority Data
Sep. 26, 2023 (JP) 2023-163689

(51) Int. Cl. H01Q 15/00; H01Q 3/44; H01Q 15/14

(52) U.S. Cl. CPC H01Q 15/0086; H01Q 3/44; H01Q 15/14

(57) ABSTRACT

Provided is a radio wave control element that has low power consumption for controlling radio waves. A radio wave control element including, in the following order: a first electrode; a liquid crystal composition layer; and a second electrode, wherein at least one of the first electrode or the second electrode has a metasurface structure in which a plurality of microstructures are arranged, the radio wave control element further includes a temperature control mechanism that heats and cools the liquid crystal composition layer, and a solid-liquid crystal phase transition temperature of the liquid crystal composition layer is 40° C. or higher, solves the problem.

### CROSS-REFERENCE TO RELATED APPLICATIONS

This application is a Continuation of PCT International Application No. PCT/JP2024/033570 filed on Sep. 20, 2024, which claims priority under 35 U.S.C. § 119(a) to Japanese Patent Application No. 2023-163689 filed on Sep. 26, 2023. The above applications are hereby expressly incorporated by reference, in their entirety, into the present application.

### BACKGROUND OF THE INVENTION

### 1. Field of the Invention

The present invention relates to a radio wave control element using a metasurface structure and a liquid crystal layer.

### 2. Description of Related Art

High-frequency radio waves (millimeter waves, terahertz waves) required for high-capacity wireless communication have high straightness. Therefore, a reflecting plate that bends radio waves in any direction is required to deliver the radio waves to a desired position.

However, for example, a direction in which the radio waves are reflected by a normal reflecting plate is constant, and the reflection direction is regular reflection in which an incidence angle and an emission angle are equal. Therefore, in the normal reflecting plate, there is a large restriction on a range in which a traveling direction of the radio waves is changed, and there is a problem that it is difficult to deliver the radio waves to a place where the radio waves are to be delivered.

In order to solve this problem, a radio wave control element that arbitrarily controls a direction of the radio waves is used.

As such a radio wave control element, an element that reflects the radio waves in a desired direction by adjusting a phase in a reflecting surface using an integrated circuit (IC) is known.

However, the radio wave control element using the IC has a problem of large power consumption.

On the other hand, as a radio wave control element having low power consumption, a radio wave control element using a liquid crystal is known. The radio wave control element applies a voltage to the liquid crystal layer interposed between electrodes to adjust an alignment state of the liquid crystal, adjusts a phase distribution in the reflecting surface, and reflects the radio waves in a desired direction.

For example, JP2023-513660A discloses a radio wave control element (tunable LC device) including a first substrate, a first reflector that is on the first substrate and includes a first electrode layer, a liquid crystal layer (LC layer) that is on the first reflector, a second reflector that is on the liquid crystal layer and includes a second electrode layer, and a second substrate that is on the second reflector, in which the liquid crystal layer is adjustable by applying an electric signal to at least one of the first or second electrode layers.

### SUMMARY OF THE INVENTION

The radio wave control element disclosed in JP2023-513660A uses a liquid crystal layer and a metasurface structure in which conductive microstructures are arranged.

In the radio wave control element, the alignment of the liquid crystal compound in a region corresponding to each electrode is adjusted by adjusting a voltage applied to each electrode as each microstructure. As a result, it is possible to adjust the phase distribution in the reflecting surface and reflect the radio waves in a desired direction.

The radio wave control element using the liquid crystal can control the traveling direction of the radio waves in the desired direction with less power consumption than the radio wave control element using the IC.

However, in the radio wave control element using the liquid crystal in the related art, since power needs to be always supplied during driving, the power consumption is still large. Therefore, it is required to improve the power consumption.

An object of the present invention is to solve such a problem in the related art and to provide a radio wave control element that uses a metasurface structure and a liquid crystal layer to control a traveling direction of radio waves and that has low power consumption for controlling the radio waves.

In order to solve the problems, the present invention has the following configuration.

[1] A radio wave control element comprising, in the following order: a first electrode; a liquid crystal composition layer; and a second electrode, wherein at least one of a first electrode or a second electrode has a metasurface structure in which a plurality of microstructures are arranged, the radio wave control element further includes a temperature control mechanism that heats and cools the liquid crystal composition layer, and a solid-liquid crystal phase transition temperature of the liquid crystal composition layer is 40° C. or higher.

[2] The radio wave control element according to [1], in which the liquid crystal composition layer, in an X-ray diffraction spectrum measured at a temperature lower than 40° C., is capable of having a peak in a range in which a diffraction angle is 15° or less.

[3] The radio wave control element according to [1] or [2], in which the liquid crystal composition layer contains a dichroic substance.

[4] The radio wave control element according to [3], in which a content of the dichroic substance is 30% by mass or more with respect to a total mass of the liquid crystal composition layer.

According to the radio wave control element of the present invention, the traveling direction of the radio waves can be controlled with less power consumption.

### BRIEF DESCRIPTION OF THE DRAWINGS

FIG. 1 is a diagram conceptually showing an example of the radio wave control element of the embodiment of the present invention.

FIG. 2 is a diagram conceptually showing an example of an application example of the radio wave control element according to the present invention.

FIG. 3 is a perspective view conceptually showing a metasurface structure of the radio wave control element shown in FIG. 1.

FIG. 4 is a conceptual diagram for describing an action of the radio wave control element according to the present invention.

FIG. 5 is a conceptual diagram for describing an action of the radio wave control element according to the present invention.

### DESCRIPTION OF THE PREFERRED EMBODIMENTS

Hereinafter, the radio wave control element of the embodiment of the present invention will be described in detail based on suitable Examples shown in the accompanying drawings.

In the present specification, numerical ranges represented by “to” include numerical values before and after “to” as lower limit values and upper limit values.

In the present specification, the meaning of “the same” includes a case where an error range is generally allowable in the technical field.

Each of the following drawings is a conceptual diagram for describing the radio wave control element according to the present invention. Therefore, the shape, size, thickness, positional relationship, and the like of each member are not necessarily matched with the actual ones.

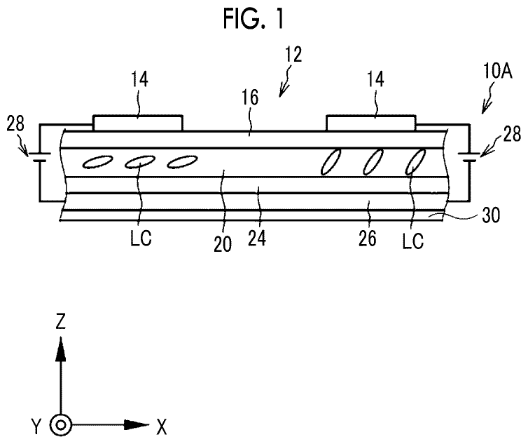

FIG. 1 conceptually shows an example of a radio wave control element (electromagnetic wave control element) according to the present invention.

The radio wave control element 10 according to the present invention is a reflective radio wave control element that controls a traveling direction of radio waves (electromagnetic waves) in a desired direction by using a reflective metasurface structure and a liquid crystal layer.

The radio wave control element according to the present invention is used, for example, in an active antenna, a beam steering device, and the like that can switch and transmit the traveling direction of the radio waves in radio wave communication and the like in an indoor and outdoor environment.

The radio wave control element 10 according to the present invention acts on radio waves having a frequency of 0.007 to 0.3 THz and reflects the radio waves in a desired direction. That is, the radio wave control element according to the present invention reflects radio waves having a wavelength of 1 to 43 mm in a desired direction.

Preferably, the radio wave control element 10 according to the present invention reflects radio waves having a frequency of 0.1 to 0.3 THz, that is, radio waves having a wavelength of 1 to 3 mm in a desired direction.

As shown in FIG. 1, the radio wave control element 10 according to the present invention includes, in the following order from the lower side in the drawing, a first electrode layer 26, a liquid crystal composition layer 20, and a metasurface structure 12.

The metasurface structure 12 is formed by two-dimensionally arranging microstructures 14 serving as resonators on a support body 16. In addition, the liquid crystal composition layer 20 is provided on a support 24.

Furthermore, the first electrode layer 26 is provided to entirely cover the surface of the support 24 on the side opposite to the liquid crystal composition layer 20.

In addition, in the radio wave control element 10 according to the present invention, a temperature control mechanism 30 is provided on a lower surface side of the first electrode layer 26 in the drawing. The temperature control mechanism 30 heats and cools the liquid crystal composition layer 20.

The temperature control mechanism 30 of the illustrated example heats the liquid crystal composition layer 20 by heating the first electrode layer 26 and cools the liquid crystal composition layer 20 by cooling the first electrode layer 26.

In the radio wave control element 10, the temperature control mechanism 30 and the first electrode layer 26, the first electrode layer 26 and the support 24, and the liquid crystal composition layer 20 and the support 16 (metasurface structure 12) are bonded to each other using a bonding agent (adhesive or adhesive) as necessary.

The bonding method is not limited, and various known methods in which radio waves targeted by the radio wave control element 10 can be transmitted, such as a method using an optical clear adhesive (OCA) through which radio waves targeted by the radio wave control element 10 can be transmitted, can be used.

In the radio wave control element 10 shown in FIG. 1, as an example, the microstructure 14 is formed of a conductive material and also serves as an electrode constituting an electrode pair together with the first electrode layer 26. In addition, a power supply 28 for applying a voltage between the microstructure 14 and the first electrode layer 26 is connected to each of the microstructures 14.

The power supply 28 is not limited, and various known alternating current power supplies that can supply the required power can be used.

As described above, the radio wave control element 10 is a reflective radio wave control element that controls the traveling direction of radio waves (electromagnetic waves) in a desired direction by using a reflective metasurface structure and a liquid crystal composition layer.

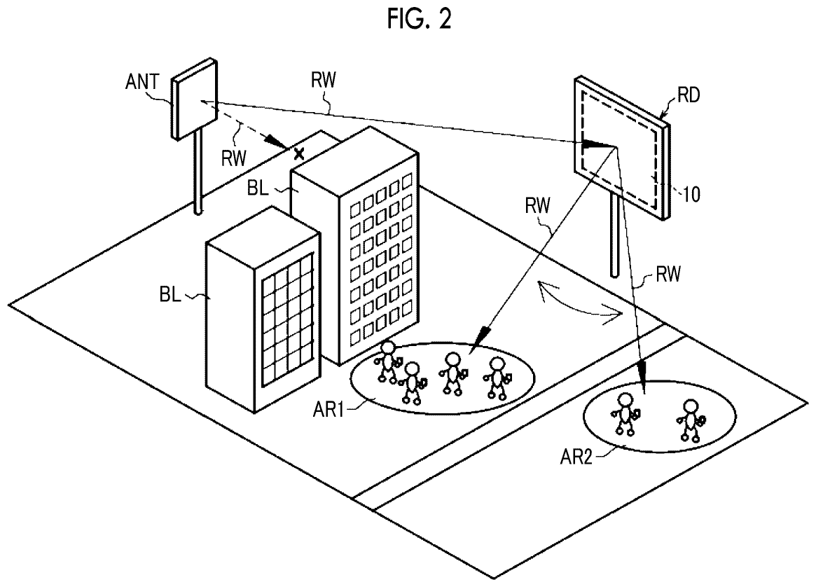

Such a radio wave control element 10 is used in, for example, a radio wave reflecting device RD (active antenna) as conceptually shown in FIG. 2. Specifically, the radio wave reflecting device RD switches the reflection direction of the radio waves RW having high directivity, which are radiated from the antenna ANT disposed behind the building BL, to a direction toward an area AR1 in front of the building BL, which is in the shade as viewed from the antenna ANT, and a direction toward an area AR2 different from the area AR1 by using the radio wave control element 10.

For example, areas where many users utilizing wireless communication are present sometimes change depending on the time slot of the day, such as the area AR1 where many users are present in the day time slot and the area AR2 where many users are present in the night time slot. In such a case, the radio wave reflecting device RD changes the area to which the radio waves RW are supplied by changing the reflection direction of the radio waves RW depending on the time of day.

In the radio wave control element 10 according to the present invention, the liquid crystal composition layer 20 undergoes a phase transition by heating, is a solid (glass state) at normal temperature, and transitions to a liquid crystal phase when heated. In a state of being in the liquid crystal phase, the alignment direction of the liquid crystal compound LC of the liquid crystal composition layer 20 can be changed by supplying power from the power supply 28 to the microstructures 14, that is, by applying a voltage between the microstructures 14 and the first electrode layer 26.

In addition, in a case where the liquid crystal composition layer 20 is cooled to return to normal temperature while maintaining the alignment of the liquid crystal compound LC by continuously applying the voltage, the alignment state of the liquid crystal compound LC is maintained even after the application of the voltage is stopped, and the liquid crystal composition layer 20 is solidified.

The temperature control mechanism 30 is used for heating and cooling the liquid crystal composition layer 20.

As described above, by supplying power to each microstructure 14 in a heated state, a voltage is applied to the liquid crystal composition layer 20 between the microstructures 14 and the first electrode layer 26, and the alignment state of the liquid crystal compound LC changes. In addition, by adjusting the power supplied to each of the microstructures 14, the voltage applied to the region of the liquid crystal composition layer 20, corresponding to the microstructure 14, can be adjusted, and thus, the alignment of the liquid crystal compound LC between the microstructure 14 and the first electrode layer 26 can be adjusted.

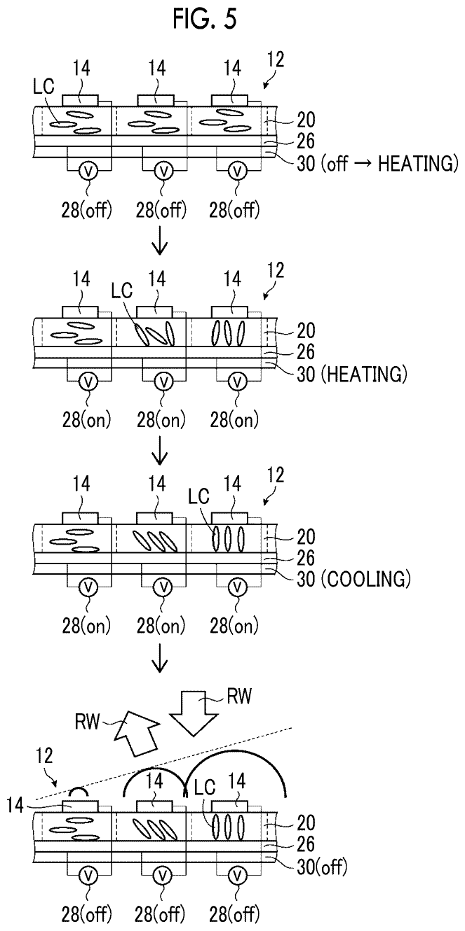

For example, in a heated state, that is, in a liquid crystal phase state, in a state where the voltage is not applied, the liquid crystal compound LC of the liquid crystal composition layer 20 is aligned in a direction parallel to a main surface of the liquid crystal composition layer 20 as conceptually shown in the upper part of FIG. 5 described below. The main surface of the liquid crystal composition layer 20 is an X-Y plane described below.

In the following description, this alignment state is also referred to as a “horizontal alignment”.

In a case where the voltage is applied to the liquid crystal composition layer 20 in a heated state, as conceptually shown in the second row from the top in FIG. 5, the alignment state of the liquid crystal compound LC in the region corresponding to the microstructures 14 changes in accordance with the strength of the applied voltage, and is tilted with respect to the thickness direction of the liquid crystal composition layer 20. In the present example, the liquid crystal compound LC is maximally aligned in the thickness direction of the liquid crystal composition layer 20. The thickness direction of the liquid crystal composition layer 20 is a Z direction described below.

In the following description, this alignment state is also referred to as a “vertical alignment”.

The thickness direction is a laminating direction of the first electrode layer 26, the support 24, the liquid crystal composition layer 20, and the support 16.

In addition, the main surface is a maximum surface of a sheet-like material (a film, a plate-like material, or a layer), and is usually on both surfaces of the sheet-like material in a thickness direction.

Furthermore, the normal direction is a direction orthogonal to a surface such as a main surface.

As described above, the radio wave control element 10 shown in FIG. 1 uses a reflective metasurface structure.

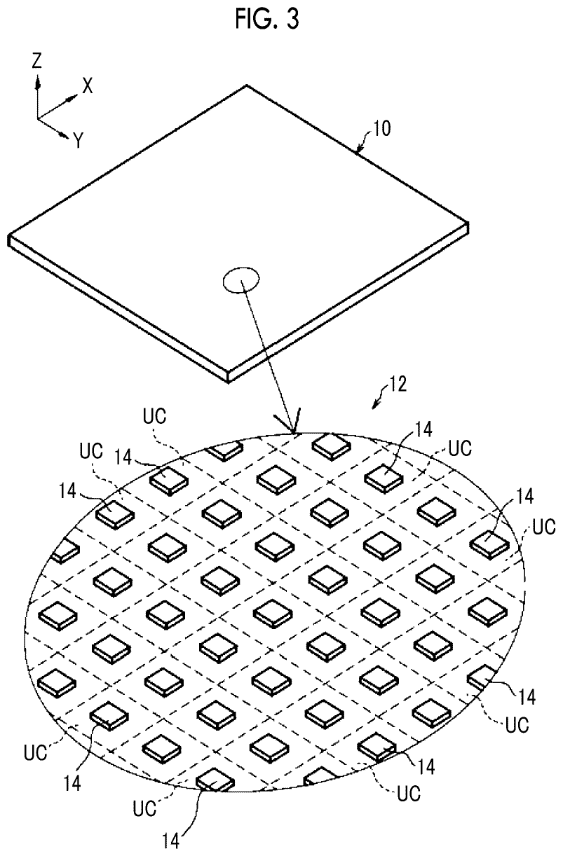

As conceptually shown in FIG. 3, in the illustrated metasurface structure 12, the microstructures 14 are, for example, rectangular flat plates in plan view, and are arranged two-dimensionally in the X and Y directions, with two sides coinciding with the mutually perpendicular X and Y directions. The planar shape is a shape as viewed from a direction orthogonal to the main surface of the sheet-like material, and is a shape as viewed from a direction orthogonal to the main surface of the support 16 in the present example.

In the metasurface structure 12, a unit cell UC of the metasurface structure is composed of one microstructure 14 and a peripheral space up to the adjacent microstructure 14 (see FIGS. 3 and 5).

In a case where electromagnetic waves are incident on the radio wave control element 10 of the embodiment of the present invention, having such a configuration, the electromagnetic waves are phase-modulated by resonance of the microstructure 14 (unit cell) in a case of transmitting through the metasurface structure 12, and further phase-modulated by being transmitted through the liquid crystal layer 20.

The radio waves are then reflected by the first electrode layer 26 that also serves as a reflective layer.

The radio waves reflected by the first electrode layer 26 are phase-modulated by transmitting through the liquid crystal composition layer 20 again, are further phase-modulated by the metasurface structure 12, and are emitted from the radio wave control element 10 as reflected radio waves.

Here, as described above, the alignment state of the liquid crystal compound LC in the liquid crystal composition layer 20, that is, the refractive index is different depending on the voltage applied to each microstructure 14 in the heated state.

That is, the effective refractive index for the radio waves changes as the alignment state of the liquid crystal compound LC changes.

In a state where the voltage is not applied to the liquid crystal composition layer 20, the liquid crystal compound LC in the liquid crystal composition layer 20 is horizontally aligned, for example.

As described above, in a case where the voltage is applied to the liquid crystal composition layer 20 in the heated state, the liquid crystal compound LC in the region corresponding to the microstructures 14 is tilted and aligned with respect to the main surface of the liquid crystal composition layer 20 in accordance with the magnitude of the applied voltage.

In addition, in a case where the liquid crystal composition layer 20 returns to normal temperature while maintaining the alignment state of the liquid crystal compound LC, that is, in a case where the voltage is applied, the liquid crystal composition layer 20 returns to the solid state, and the alignment of the liquid crystal compound LC is maintained even after the application of the voltage is stopped.

In the radio wave control element 10, as the voltage applied to the liquid crystal composition layer 20 is larger, the liquid crystal compound LC is closer to the vertical alignment, and the refractive index of the liquid crystal composition layer 20 in the region changes from the state where the voltage is not applied. That is, in the liquid crystal composition layer 20, the refractive index of the corresponding region, that is, the phase difference given to the transmitted radio waves can be changed depending on the voltage applied to each microstructure 14.

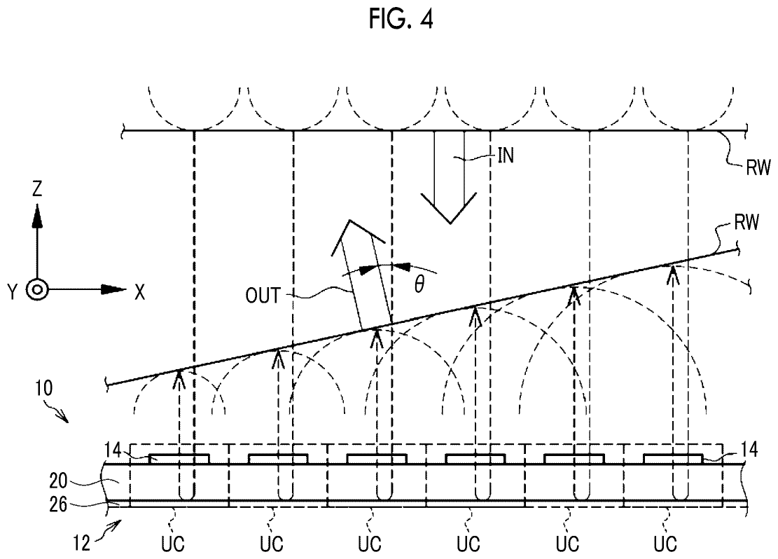

In FIG. 4, as conceptually shown in the incidence direction IN and the emission direction OUT, the overall traveling direction of the radio waves RW can be considered as a normal direction with respect to a straight line connecting the wavefronts of the plurality of radio waves RW.

In the radio wave control element 10, for example, it is considered that the amount of phase delay of the radio waves RW incident on and reflected by each of the plurality of unit cells UC arranged in one dimension increases gradually from the unit cell UC on the right side in the drawing to the unit cell UC on the left side in the drawing. In this case, even in a case where the straight line connecting the wavefronts of the incident individual radio waves RW is parallel to the reflecting surface, the straight line connecting the wavefronts of the individual radio waves RW reflected by each unit cell UC is tilted with respect to the reflecting surface. That is, the emission direction OUT, which is a traveling direction of the radio wave RW emitted from the reflecting surface, is changed by an angle θ with respect to the incidence direction IN of the radio wave RW.

In this way, the traveling direction of the radio wave RW can be controlled by performing the phase modulation, that is, controlling the delay amount of the phase for each unit cell UC.

That is, in the radio wave control element 10, by adjusting the power supplied to each microstructure 14 to adjust the voltage applied to the corresponding region and adjust the alignment of the liquid crystal compound in the liquid crystal composition layer 20, regions in which the refractive index is different in the plane direction of the liquid crystal composition layer 20 can be generated.

As a result, the incident radio waves can be reflected in a direction different from the specular reflection. For example, in a case where the radio waves are incident from the normal direction of the liquid crystal composition layer 20, the radio waves are reflected in a direction tilted with respect to the normal direction, instead of the normal direction.

In addition, by changing the power supplied to each microstructure 14 to change the voltage applied to the corresponding region of the liquid crystal composition layer 20, the alignment state of the liquid crystal compound, that is, the refractive index, that is, the phase at each position in the plane direction can be adjusted, and the reflection direction of the incident radio waves can be switched.

As described above, the radio wave control element 10 according to the present invention is an active radio wave control element that can change the reflection direction of the incident radio waves by adjusting the power supplied to each microstructure 14.

In the radio wave control element 10 according to the present invention, the metasurface structure 12 is formed by two-dimensionally arranging the microstructures 14, which are microstructures, on the support 16, as in a known metasurface structure.

As described above, in the metasurface structure 12 of the illustrated example, the microstructures 14 have a rectangular planar shape and are two-dimensionally arranged at equal intervals in the X direction and the Y direction orthogonal to each other.

The support 16 is not limited, and various known sheet-like materials can be used as long as the microstructures 14 can be supported and the radio waves, for example, the radio waves having a frequency of 0.007 to 0.3 THz, which are the target of the radio wave control element 10 can be transmitted.

Examples of the support 16 include a metal substrate having an oxide insulating layer such as a silicon substrate having silicon oxide, a substrate consisting of an oxide such as silicon oxide, a substrate consisting of a semiconductor such as germanium and chalcogenide glass, a resin film such as a polyacrylic resin film such as polymethyl methacrylate, a cellulose resin film such as cellulose triacetate, a cycloolefin polymer film (for example, trade name “ARTON”, manufactured by JSR Corporation, trade name “ZEONOR”, manufactured by Zeon Corporation), a polyethylene terephthalate (PET) film, a polycarbonate film, and a polyvinyl chloride film, a liquid crystal polymer (LCP) film, and a glass plate.

The thickness of the support 16 is not limited, and a thickness that can support the microstructures 14, can obtain sufficient transmittance for the target radio waves, and can obtain sufficient strength depending on the application of the radio wave control element 10 may be appropriately set according to the material forming the support 16.

Furthermore, in the radio wave control element 10 of the embodiment of the present invention, the metasurface structure 12 is not limited to ones having the support body 16.

That is, in the radio wave control element of the embodiment of the present invention, the metasurface structure 12 may be formed by directly arranging the microstructures 14 on a surface of the liquid crystal layer 20 if possible.

The microstructures 14 are arranged on one surface of the support body 16. As a result, the metasurface structure 12 is formed.

The metasurface structure 12 is formed by two-dimensionally arranging the microstructures 14 on a plane with a spacing therebetween, and is basically composed of an arrangement of unit cells formed of one microstructure 14 and a space around the microstructure 14.

In the radio wave control element 10 of the embodiment of the present invention, the metasurface structure is basically a known metasurface structure (metamaterial). Accordingly, in the radio wave control element 10 of the embodiment of the present invention, various known metasurface structures can be used.

That is, in the present invention, the shape and the material for forming the microstructure 14, the arrangement of the microstructures 14, the interval (pitch) of the microstructures 14, and the like are not limited.

In addition, the metasurface structure 12 may be designed by a known method according to the reflection characteristics of the radio waves that are the target of the radio wave control element 10 according to the present invention. As an example, the amplitude and the phase of the radio waves reflected by the microstructure 14 to be used may be calculated using commercially available simulation software, and the arrangement of the microstructures 14 may be set to obtain a desired distribution of the phase modulation amount (refractive index).

The radio wave control element 10 according to the present invention is, for example, a radio wave control element that targets radio waves having a frequency of 0.007 to 0.3 THz, preferably 0.1 to 0.3 THz.

Accordingly, in the metasurface structure 12, the microstructure 14 is selected such that a desired phase difference is imparted to the radio waves having the frequency, and further, the arrangement of the microstructures, and the like are set.

The metasurface structure 12 is basically composed of an arrangement of unit cells formed of one microstructure 14 and a space around the microstructure 14. The metasurface structure 12 modulates the phase of incident radio waves by utilizing a resonance of the microstructure 14 by arranging the unit cells.

Furthermore, in the radio wave control element 10 of the embodiment of the present invention, the number of the microstructures 14 included in one unit cell is basically one, but the present invention is not limited thereto. That is, in the radio wave control element of the embodiment of the present invention, one unit cell may have a plurality of microstructures 14 as necessary depending on the desired optical characteristics, the size, the formation material, and the shape of the microstructure 14, the size of the unit cell, and the like. In this case, one unit cell may have different microstructures 14. It should be noted that in a case where one unit cell has the plurality of microstructures 14, basically, the phase modulation amounts in the space where each microstructure of the unit cell is present are the same.

In the radio wave control element 10 of the embodiment of the present invention, the material for forming the microstructure 14 constituting the metasurface structure 12 is not limited, and various materials used as the microstructure in a known metasurface structure can be used.

Examples of the material for forming the microstructure 14 include a metal and a dielectric. In a case of a metal, copper, gold, and silver are preferably exemplified from the viewpoint of low optical loss. In addition, as the material for forming the microstructure 14, a composite body consisting of metal particles and a binder, and an oxide semiconductor can also be used. On the other hand, in a case of a dielectric substance, silicon, titanium oxide, and germanium are preferably exemplified from the viewpoint that the refractive index is large and a large phase modulation is possible.

Furthermore, as shown in FIG. 1, in a case where the microstructure 14 also serves as an electrode forming an electrode pair together with the first electrode layer 26, the microstructure 14 is formed of a conductor.

Similarly, the shape of the microstructure 14 constituting the metasurface structure 12 is not also limited and various shapes that can be used as a microstructure in known metasurface structures can be used.

Examples of the shape include a cross-like three-dimensional structure in which cuboids intersect with each other, a cuboid shape, a cylindrical shape, a V-like three-dimensional structure in which cuboids are connected to end parts as described in JP2018-046395A, an H-like three-dimensional structure such as H-steel, and a substantially C-like three-dimensional structure such as a C-channel.

In addition, as the V-like three-dimensional structure as shown in JP2018-046395A, and the cross-like three-dimensional structure, various shapes where an angle between two cuboids is adjusted can be used.

In addition to those, the three-dimensional structure having a bottom surface shape as shown in FIG. 5 of “Appl. Sci. 2018, 8 (9), 1689; https://doi.org/10.3390/app8091689”, or the like can also be used.

In the metasurface structure 12, such microstructures 14 may be used alone or in combination of a plurality of kinds thereof. In addition, the same microstructures 14 may be arranged in the same orientation as or different orientation from that as shown in FIG. 3, or the microstructures arranged in the same orientation and the microstructures arranged in different orientations may be mixed.

In the example shown in the drawing, in a preferred aspect, in the metasurface structure 12, the same microstructures 14 having the same structure are two-dimensionally arranged in the same orientation and at regular intervals in the X direction and the Y direction orthogonal to each other.

However, the present invention is not limited thereto, and a plurality of kinds of the microstructures may be used in combination as described above, and the arrangement interval and the arrangement of the microstructures 14 may also be different in the plane direction of the support body 16.

However, in consideration of the controllability of the reflection direction of the radio waves in a state where the liquid crystal compound LC is aligned by applying the voltage to the liquid crystal composition layer 20, it is preferable that the metasurface structure 12 uses the same microstructures 14. Furthermore, in the metasurface structure 12, it is more preferable that the same microstructures 14 are two-dimensionally arranged at regular intervals, and it is still more preferable that the same microstructures 14 are two-dimensionally arranged in the same orientation and at regular intervals in the X direction and the Y direction orthogonal to each other.

In the radio wave control element 10 shown in FIG. 1, the metasurface structure 12 is one, but the present invention is not limited thereto.

That is, in the radio wave control element according to the present invention, the first electrode layer 26 side may also be a metasurface structure. In other words, the radio wave control element according to the present invention may include two metasurface structures with the liquid crystal composition layer interposed therebetween. In this case, the two metasurface structures may be the same or different from each other. In addition, the two metasurface structures may be the same structure provided by shifting the position of the microstructures.

The liquid crystal composition layer 20 is a layer in which the liquid crystal compound LC is aligned in a predetermined state, is a solid (glass state) at normal temperature, and transitions to a liquid crystal phase when heated, and the alignment of the liquid crystal compound LC can be changed by applying a voltage. The liquid crystal composition layer 20 preferably undergoes a phase transition from a solid to a nematic phase when heated.

Therefore, in the liquid crystal composition layer 20, in a state where the liquid crystal phase is transitioned by heating, as described above, the alignment state of the liquid crystal compound LC changes in accordance with the power supplied to each microstructure 14 by applying a voltage between the microstructures 14 and the first electrode layer 26. In the liquid crystal composition layer 20, the alignment state of the liquid crystal compound LC is horizontal alignment in a steady state, and is tilted with respect to the main surface of the liquid crystal composition layer 20 and is closer to vertical alignment as the applied voltage is higher.

In addition, in a case where the liquid crystal compound LC is cooled and returns to normal temperature while maintaining the alignment by applying the voltage, the liquid crystal compound LC returns to the solid state while maintaining the alignment. In the liquid crystal composition layer 20, the alignment of the liquid crystal compound in the state where the voltage is applied is maintained even after the application of the voltage is stopped.

That is, in the radio wave control element 10 according to the present invention, the alignment of the liquid crystal compound LC is adjusted by heating and applying the voltage, and then the temperature is lowered to normal temperature (phase transition temperature or lower) in a state where the voltage is applied, so that the alignment of the liquid crystal compound LC can be maintained even after the power supply is stopped. Therefore, in the radio wave control element 10, the reflection direction of the incident radio waves can be controlled in a desired direction without applying the voltage to the liquid crystal composition layer 20.

Therefore, with the radio wave control element 10 according to the present invention, the power consumption for the radio wave control can be significantly suppressed.

In addition, the reflection direction of the radio waves can be changed by heating the liquid crystal composition layer 20 to supply power to each microstructure 14 again to change the alignment of the liquid crystal compound LC, and then cooling the liquid crystal composition layer 20, so that the radio waves can be controlled in another desired direction from a state where the reflection direction of the radio waves is controlled in a certain direction. That is, as described above, the radio wave control element 10 according to the present invention is an active radio wave control element in which the reflection direction (control direction) of the radio waves can be arbitrarily changed.

In the liquid crystal composition layer 20 of the radio wave control element 10 of the illustrated example, the alignment of the liquid crystal compound LC is horizontal alignment in a steady state.

Therefore, in a case where the power supply is stopped in a state of being heated to the phase transition temperature or higher, the liquid crystal compound LC returns to the horizontal alignment.

In the present invention, the liquid crystal composition layer 20 is a layer having a solid-liquid crystal phase transition temperature of 40° C. or higher, preferably a solid-nematic phase transition temperature of 40° C. or higher.

In a case where the solid-liquid crystal phase transition temperature of the liquid crystal composition layer 20 is lower than 40° C., the phase transition occurs even at a temperature close to the normal temperature, and the alignment of the liquid crystal compound LC may be changed. That is, in a case where the solid-liquid crystal phase transition temperature of the liquid crystal composition layer 20 is lower than 40° C., in a case where the voltage is applied to the liquid crystal composition layer 20 after cooling, and then the application of the voltage is stopped, the alignment of the liquid crystal compound LC returns to the horizontal alignment. Therefore, in a case where the solid-liquid crystal phase transition temperature of the liquid crystal composition layer 20 is lower than 40° C., in order to control the radio waves, it is necessary to always apply the voltage as in the radio wave control element in the related art described in JP2023-513660A, and the power consumption is increased.

The solid-liquid crystal phase transition temperature of the liquid crystal composition layer 20 is preferably 50° C. or higher, more preferably 60° C. or higher, and still more preferably 80° C. or higher.

The upper limit of the solid-liquid crystal phase transition temperature of the liquid crystal composition layer 20 is basically not limited. However, in consideration of the energy required to cause the liquid crystal composition layer 20 to undergo a phase transition, prevention of damage to other members due to heat, prevention of thermal expansion, and the like, the phase transition temperature is preferably 120° C. or lower.

In the radio wave control element according to the present invention, the solid-liquid crystal phase transition temperature of the liquid crystal composition layer 20 is measured by observing the liquid crystal composition for forming the liquid crystal composition layer 20 with a polarizing microscope, for example. That is, the liquid crystal composition for forming the liquid crystal composition layer 20 may be heated to a temperature at which the liquid crystal composition is in the liquid crystal phase while observing the liquid crystal composition layer 20 with a polarizing microscope, and then the temperature at which the liquid crystal composition is in a phase other than the liquid crystal phase such as a crystal phase may be measured while cooling the liquid crystal composition.

Alternatively, the support 16 or the support 24 may be peeled off to expose the liquid crystal composition layer 20, the liquid crystal composition layer 20 may be sampled by a method such as cutting, and the solid-liquid crystal phase transition temperature of the liquid crystal composition layer 20 may be measured by the above-described method using the sample. In addition, the solid-liquid crystal phase transition temperature may be measured by thermal analysis such as differential scanning calorimetry (DSC) and thermogravimetry (TG). In addition, the solid-liquid crystal phase transition temperature may be measured by identifying the phase by an X-ray diffraction method (XRD).

In addition, the thickness of the liquid crystal composition layer 20 is not limited, and the thickness for imparting a phase difference required for the radio wave may be appropriately set depending on a material for forming the liquid crystal composition layer 20.

In the present invention, the liquid crystal composition layer 20 may be formed on the surface of the alignment film described below by a known method according to the liquid crystal compound or the like to be used, for example.

The liquid crystal composition layer 20 will be described in detail below.

In the radio wave control element 10, the liquid crystal composition layer 20 is formed on the support 24.

The support 24 is basically the same as the above-described support 16.

Here, the support 24 on which the liquid crystal composition layer 20 is formed may have an alignment film for aligning the liquid crystal compound LC in a predetermined state on a surface of the support 24 on which the liquid crystal composition layer 20 is formed, as a base material, the same as the support 16 described above.

As the alignment film, various known films can be used. Examples of the alignment film include a rubbing-treated film consisting of an organic compound such as a polymer, an obliquely vapor-deposited film with an inorganic compound, a film having a microgroove, and a film formed by lamination of Langmuir-Blodgett (LB) films formed with a Langmuir-Blodgett's method using an organic compound such as ω-tricosanoic acid, dioctadecylmethylammonium chloride, and methyl stearate.

In addition, as the alignment film, a so-called photo-alignment film obtained by irradiating a photo-alignable material with polarized light or non-polarized light can be used.

These alignment films may be formed by a known method depending on a material for forming the main body.

The surface of the support 24 forming the liquid crystal composition layer 20 on a side opposite to the liquid crystal composition layer 20 is entirely covered with the first electrode layer 26.

The first electrode layer 26 is an electrode that changes the alignment of the liquid crystal compound LC in the liquid crystal composition layer 20, and also acts as a reflecting layer that reflects the radio waves incident from the metasurface structure 12 side as described above.

The first electrode layer 26 is not limited, and a sheet-like material consisting of various known materials can be used as long as it has sufficient conductivity and can reflect the target radio waves.

Examples of the first electrode layer 26 include metal layers such as copper, aluminum, gold, and silver, inorganic conductive materials such as indium tin oxide (ITO), organic conductive materials such as polythiophene typified by poly(3,4-ethylenedioxythiophene) (PEDOT), and graphene. The inorganic conductive material, the organic conductive material, the graphene, and the like are transparent to visible light, but act as a reflective layer with respect to the radio waves having the frequency.

The thickness of the first electrode layer 26 is not limited, and the thickness with which radio waves as a target can be reflected with a required reflectivity may be appropriately set depending on the material for forming the first electrode layer 26.

As described above, in the radio wave control element 10, the temperature control mechanism 30 is provided on the lower surface side of the first electrode layer 26 in the drawing.

The temperature control mechanism 30 heats and cools the liquid crystal composition layer 20, heats the liquid crystal composition layer 20 by heating the first electrode layer 26, and cools the liquid crystal composition layer 20 by cooling the first electrode layer 26.

In the radio wave control element 10 of the illustrated example, the liquid crystal composition layer 20 is heated by the temperature control mechanism 30 to transition the liquid crystal composition layer 20 from a solid (solid phase) to a liquid crystal phase.

In addition, after adjusting the alignment of the liquid crystal compound LC in the liquid crystal phase, the liquid crystal composition layer 20 is cooled by the temperature control mechanism 30 to return the liquid crystal composition layer 20 to the solid state. As described above, in the radio wave control element 10 according to the present invention, the alignment state of the liquid crystal compound LC can be maintained even after the application of the voltage to the microstructures 14 is stopped in this state, and the power consumption for the radio wave control can be reduced.

In the radio wave control element 10 according to the present invention, the temperature control mechanism 30 is provided with not only a heating unit for transitioning the liquid crystal composition layer 20 to the liquid crystal phase but also a cooling unit for cooling the liquid crystal composition layer 20, and the liquid crystal composition layer 20 is rapidly cooled after the alignment of the liquid crystal compound is controlled. As a result, the liquid crystal composition layer 20 can be prevented from being unnecessarily crystallized by cooling, and the solidified liquid crystal composition layer 20 can be brought into a suitable state in which a peak is present in a range in which the diffraction angle is 15° or less in an X-ray diffraction spectrum described below.

The temperature control mechanism 30 is not limited, and various temperature control units using known heating units and cooling units can be used.

Examples of the heating unit include a method of directly or indirectly bringing a warm medium such as hot water into contact with the liquid crystal composition layer 20, heating by radiation heat using a heater of a resistance heating method using Joule heat, heating by hot air, and heating using a Peltier element.

Examples of the cooling unit include a method of directly or indirectly bringing a coolant such as cold water into contact with the liquid crystal composition layer 20, cooling using a Peltier element, and cooling by cold air.

A plurality of heating units and cooling units may be used in combination.

In the illustrated example, the temperature of the liquid crystal composition layer 20 is controlled by controlling the temperature of the first electrode layer 26, but the present invention is not limited thereto.

For example, the temperature of the liquid crystal composition layer 20 may be controlled by controlling the temperature of the microstructures 14 of the metasurface structure 12 and/or the support 16. Alternatively, the liquid crystal composition layer 20 may be directly heated and cooled.

In addition, in a case of heating and cooling the liquid crystal composition indirectly as in the illustrated example, the heating may be performed using the first electrode layer 26 and the cooling may be performed using the metasurface structure 12, for example, and the heating and the cooling may be performed at different positions.

Hereinafter, an action of the radio wave control element 10 according to the present invention will be described with reference to the conceptual diagram of FIG. 5.

In FIG. 5, in order to simplify the drawing and clearly show the action of the radio wave control element 10 according to the present invention, only the microstructures 14 (metasurface structure 12), the liquid crystal composition layer 20, the first electrode layer 26, and the power supply 28 are shown in the drawing. In addition, in FIG. 5, the broken line indicates a unit cell (unit cell UC) corresponding to each microstructure 14.

As described above, in the radio wave control element 10, in a steady state, as shown in the upper part of FIG. 5, the liquid crystal compound LC of the liquid crystal composition layer 20 is horizontally aligned (substantially horizontally aligned).

In this state, the heating of the liquid crystal composition layer 20 is started by the temperature control mechanism 30. The heating of the liquid crystal composition layer 20 is started, and in a case where the temperature exceeds the transition temperature, the liquid crystal composition layer 20 transitions from the solid to the liquid crystal phase. In this state, the power supply 28 is not driven (off).

In a state where the liquid crystal composition layer 20 has transitioned to the liquid crystal phase, the power supply 28 is driven (on) to supply power to the microstructures 14 that act as the first electrode, and a voltage is applied to the liquid crystal composition layer 20.

As a result, as shown in the second row from the top in FIG. 5, the alignment state of the liquid crystal compound LC of the liquid crystal composition layer 20 changes in accordance with the power supplied to each microstructure 14, that is, the applied voltage. In the illustrated example, the applied voltage of the unit cell on the right side in the drawing is the highest, and the liquid crystal compound LC is in a state of vertical alignment. In addition, the unit cell on the left side in the drawing is not substantially applied with the voltage and remains horizontally aligned. Further, in the unit cell in the center in the drawing, a potential between the two is applied, and the liquid crystal compound LC is in an alignment state between the horizontal alignment and the vertical alignment.

In a case where the alignment state of the liquid crystal compound LC is stabilized, as shown in the third row from the top in FIG. 5, the liquid crystal composition layer 20 is cooled by the temperature control mechanism 30 while maintaining the driving state (on) of the power supply 28.

In a state where the temperature of the liquid crystal composition layer 20 is normal temperature (transition temperature or lower), as shown in the lower part of FIG. 5, the driving of the power supply 28 is stopped (off), and the application of the voltage is stopped. As described above, in this state, the alignment of the liquid crystal compound LC is maintained in the same state as the state where the voltage is applied even in a case where the voltage is not applied. The temperature control mechanism 30 is basically stopped (off) at a point in time when the temperature is normal temperature, but the temperature control is performed to maintain the normal temperature as necessary.

Therefore, in a case where the radio waves RW are incident in this state, as described with reference to FIG. 4, the incident radio waves RW are given a phase corresponding to the alignment state of the liquid crystal compound LC corresponding to the applied voltage, and are reflected in a predetermined direction by controlling the reflection direction.

Therefore, with the radio wave control element 10 according to the present invention, the power consumption for the radio wave control can be significantly suppressed.

In addition, the reflection direction of the incident radio waves RW can be changed by re-heating the liquid crystal composition layer 20 from the state shown on the right side of FIG. 5, supplying power to each microstructure 14 again to adjust the alignment of the liquid crystal compound LC, and then cooling the liquid crystal composition layer 20, so that the traveling direction of the radio waves RW can be controlled in another desired direction.

As described above, in the radio wave control element 10 according to the present invention, the liquid crystal composition layer 20 is a solid at normal temperature, has a solid-liquid crystal phase transition temperature of 40° C. or higher, and preferably has a solid-nematic phase transition temperature of 40° C. or higher.

Here, it is preferable that the liquid crystal composition layer 20 of the radio wave control element according to the present invention can have a peak in a range in which a diffraction angle is 15° or less in an X-ray diffraction spectrum (XRD spectrum) measured at a temperature lower than 40° C.

The liquid crystal composition layer 20 having a peak in such an XRD spectrum has a high alignment degree (=Δn), and can suitably control the radio waves having a frequency of 0.007 to 0.3 THz.

In the XRD spectrum, the peak in a range in which the diffraction angle is 15° or less means that a periodic structure such as a crystal phase and a smectic phase is present in the liquid crystal composition layer 20.

In a case where the liquid crystal composition layer 20 that transitions to the liquid crystal phase (nematic phase) at 40° C. or higher is cooled from a temperature of the solid-liquid crystal phase transition temperature or higher to room temperature, a glass state in which molecular fluctuations of the liquid crystal phase are frozen is formed, but a periodic structure such as a crystal phase and a smectic phase is mixed in the glass state, so that the radio wave control element 10 having a high alignment degree is obtained.

In general, it is known that the crystal phase and the smectic phase, which are higher-order phases than the nematic phase, have a high alignment degree. Therefore, it is considered that the liquid crystal composition layer 20 exhibits a high alignment degree by mixing such a higher-order phase in the glass state.

In a case where the alignment degree of the liquid crystal composition layer 20 is high, the refractive index anisotropy (Δn) can be increased. The Δn increases as the anisotropy (intrinsic birefringence) of the molecules contained in the liquid crystal composition layer 20 is larger, but the Δn increases as the alignment degree representing the degree to which the molecules are aligned in a certain direction is higher.

In general, the nematic liquid crystal and the glass state immobilized by cooling the nematic liquid crystal or the like exhibit an alignment degree of about 0.6 to 0.85. On the other hand, the smectic liquid crystal and the crystal phase, which are higher-order phases, exhibit an alignment degree higher than 0.85.

It is considered that the alignment degree of the liquid crystal composition layer 20 is higher than 0.85 by mixing such a higher-order phase in the glass state.

Since the glass state immobilized by cooling the liquid crystal phase does not have a periodic structure, periodicity is generally not observed, and a broad peak (halo) due to an average intermolecular distance is observed in the XRD spectrum.

On the other hand, higher-order phases such as the crystal phase and the smectic phase generally form a periodic structure such as a layer structure, and a peak corresponding to the length of the layer is observed in the XRD spectrum. In general, the halo observed in the nematic phase and the glass state has an angle wider than 15°. The length of the layer is an interval of the periodic structure and is also referred to as a period length.

That is, in the XRD spectrum, the peak at an angle of 15° or less indicates that a higher-order phase having a periodic structure, such as a crystal phase and a smectic phase, is included.

The XRD of the liquid crystal composition layer 20 may be measured using, for example, the liquid crystal composition for forming the liquid crystal composition layer 20.

For example, the liquid crystal composition for forming the liquid crystal composition layer 20 is dissolved in a solvent, and is spin-coated on a general alignment film such as polyimide subjected to a rubbing treatment to produce a film.

This film is heated to a temperature above 40° C. at which it transitions to a liquid crystal phase, in order to achieve the same temperature process as that actually used in radio wave control elements, and a liquid crystal phase is formed in which the liquid crystal compound LC in the liquid crystal composition is aligned. Then, the film is cooled to below 40° C. (below the transition temperature) to obtain a sample of liquid crystal composition layer 20 in which the liquid crystal composition is fixed. The XRD of the liquid crystal composition layer is measured using this sample as shown below.

Alternatively, the support 16 or the support 24 may be peeled off to expose the liquid crystal composition layer 20, the liquid crystal composition layer 20 may be sampled by a method such as cutting, and the sample may be treated in the same manner as the above-described liquid crystal composition to obtain a sample of the liquid crystal composition layer 20.

Next, the XRD spectrum is measured by an in-plane method. The measurement is performed in a state where the liquid crystal composition layer is maintained at 40° C. or lower.

Hereinafter, the X-ray diffraction analysis performed using the in-plane method is also described as “in-plane XRD”. The in-plane XRD is performed by irradiating the sample surface with X-rays under the following conditions using a thin film X-ray diffraction device.

### (Conditions)

Cu ray source to be used (CuKα, output of 45 kV, 200 mA)
X-ray incidence angle of 0.2°
Used optical system: parallel optical system (cross beam optics (CBO)) (parallel beam (PB))
Incidence side Incidence slit: 0.2 mm, incidence parallel slit in-plane PSC (parallel slit collimator): 0.5 deg (degree), longitudinal restriction slit: 10 mm
Light-receiving side Light-receiving slit: 20 mm, light-receiving parallel slit in-plane PSA (parallel slit analyzer): 0.5 deg
Detector: HyPix3000 (OD mode) manufactured by Rigaku Corporation
2θχ/φ scan Scan condition: 0.008 degree/step, 2.0 degree/min (minute) in a range of 1 to 40 degree
φ scan Scan condition: 0.5 degree/step, 9.6 degree/min in a range of −120 to 120 degree

The above conditions are set values in the thin film X-ray diffraction device. A well-known device can be used as the thin-film X-ray diffractometer. As the thin-film X-ray diffractometer, SmartLab manufactured by Rigaku Corporation can be exemplified.

The sample is disposed on the X-ray diffraction device such that the major axis direction (alignment axis direction) of the aligned liquid crystal compound LC and the incidence X-rays are parallel to each other. The azimuthal angle (φ) here is set to 0°.

The alignment axis direction is measured as follows.

In-plane XRD (2θχ/φ scan) is performed such that the periodic structure in the alignment axis direction is observed. The direction orthogonal to the orientation in the substrate plane where the peak intensity is the maximum is set as a direction of the alignment axis by φ scan performed on the observed peak at every 0.5°.

In-plane XRD (2θχ/φ scan) was performed at every 0.5° in an azimuthal angle (φ) range of 0° to 90°, and thus the orientation in the substrate plane where the peak intensity is the maximum is determined by φ scan performed on the observed peak.

The XRD spectrum is acquired by performing in-plane XRD (2θχ/φ scan) in the orientation in which the peak intensity is maximum. The diffraction angle θ is a diffraction angle 2θχ/φ in 2θχ/φ scan of the in-plane XRD.

Here, in a case where the peak top intensity is higher than the baseline intensity by 80 or greater in the XRD spectrum, this is regarded as a peak. The baseline intensity is defined by a known method.

The unit of the intensity of the peak is cps (count per second).

The peak intensity is a difference between the baseline intensity and the peak top intensity.

In the radio wave control element 10 according to the present invention, it is preferable that, in a case where the liquid crystal composition layer 20 is in a state of being lower than 40° C., the peak of the XRD spectrum of the liquid crystal composition layer 20 measured in this way is present in a range of the diffraction angle of 15° or less.

As described above, the peak in a range of the diffraction angle of 15° or less means that a higher-order phase having a periodic structure, such as a crystal phase and a smectic phase, is included. The peak is present preferably in a diffraction angle range of 1° to 15°, more preferably in a diffraction angle range of 1.5° to 15°, and still more preferably in a diffraction angle range of 1.8° to 15°.

Here, the amount and the state of the higher-order phase having a periodic structure, such as the crystal phase and the smectic phase, present in the liquid crystal composition layer 20 at a temperature lower than 40° C. in a case where the liquid crystal compound LC is aligned by applying the voltage to the liquid crystal composition layer 20 and then cooled to normal temperature (phase transition temperature) to be solidified vary depending on the time taken to return to the normal temperature.

Specifically, in order to form the periodic structure of the higher-order phase appropriately, to increase the alignment degree of the liquid crystal composition layer 20, and to increase the refractive index anisotropy (Δn), it is necessary to cool the liquid crystal composition layer 20 to normal temperature to some extent rapidly after applying the voltage to the liquid crystal composition layer 20 to align the liquid crystal compound LC.

As described above, in the radio wave control element 10 according to the present invention, the temperature control mechanism 30 heats and cools the liquid crystal composition layer 20, and has a cooling unit in addition to the heating unit.

In the radio wave control element 10 according to the present invention, the temperature control mechanism 30 that performs the temperature control of the liquid crystal composition layer 20 has the cooling unit (cooling function), so that the cooling to normal temperature after applying the voltage to the liquid crystal composition layer 20 to align the liquid crystal compound LC can be performed rapidly.

Therefore, the radio wave control element 10 according to the present invention can increase the alignment degree (=Δn) of the liquid crystal composition layer 20 in a case of stably controlling the radio waves. With such a radio wave control element 10 according to the present invention, the radio waves having a frequency of 0.007 to 0.3 THz can be suitably controlled stably.

In the present invention, from the viewpoint of further increasing the alignment degree, in the liquid crystal composition layer 20, a half-width of the peak in the φ scan with respect to the periodic structure corresponding to at least one peak having a diffraction angle of 15° or less is preferably 30° or less, more preferably 3° to 23°, and still more preferably 3° to 20°.

As is well known, the result of the φ scan shows the directions of measured periodic structures that exist and the degree of distribution thereof. Therefore, as the half-width of a peak decreases, the measured periodic structures are present in the same direction, which means that the degree of alignment is high.

The half-width of the peak may be acquired by fitting the observed peak to the gauss function.

The liquid crystal composition layer 20 need only have a half-width of the peak in the φ scan with respect to the periodic structure corresponding to at least one peak having a diffraction angle of 15° or less of 30° or less, but it is preferable that the half-width of the peak in the φ scan with respect to the periodic structure corresponding to the peak having a diffraction angle of 15° or less is 30° or less.

In the present invention, it is preferable that the liquid crystal composition layer 20 has a peak A observed in a direction other than a range of ±5° in a direction orthogonal to the alignment axis in the direction in which the liquid crystal composition is aligned. That is, it is preferable that the peak A is observed in a range where the azimuthal angle φ is ±85°.

The alignment degree of the liquid crystal composition layer 20 (sample) can be confirmed by the following method.

A sample is set on a sample stage in a state where the liquid crystal composition layer 20 is inserted on a light source side of an optical microscope (ECLIPSE E600 POL manufactured by Nikon Corporation), the absorbance of the sample is measured using a multi-channel spectrometer (QE65000 manufactured by Ocean Optics, Inc.), and the alignment degree is calculated by the following expression.

$$Alignment degree : S = [ ( Az 0 / Ay 0 ) - 1 ] / [ ( Az 0 / Ay 0 ) + 2 ]$$

Az0: absorbance of sample with respect to polarization in absorption axis direction
Ay0: absorbance of sample with respect to polarization in transmission axis direction

In a case where the sample does not have absorption in visible light, the alignment degree can be confirmed by the same method by infrared spectroscopy.

For a peak of a wave number derived from the vibration of the molecule in the alignment axis direction, a peak intensity with respect to the polarization in the alignment axis direction is defined as Az0, a peak intensity with respect to the polarization in the direction orthogonal to the alignment axis direction is defined as Ay0, and the alignment degree can be calculated by the above expression.

In the radio wave control element 10 according to the present invention, the liquid crystal compound constituting the liquid crystal composition layer 20 is not limited. Therefore, either a low-molecular-weight liquid crystal compound or a high-molecular-weight liquid crystal compound can be used.

Here, the “low-molecular-weight liquid crystal compound” denotes a liquid crystal compound having no repeating units in the chemical structure. In addition, the “polymer liquid crystal compound” refers to a liquid crystal compound including a repeating unit in a chemical structure.

Examples of the low-molecular-weight liquid crystal compound include compounds described in JP2013-228706A. Further, examples of the polymer liquid crystal compound include compounds described in JP2011-237513A.

The liquid crystal compound is preferably a thermotropic liquid crystal, and may exhibit either a nematic phase or a smectic phase, but preferably exhibits at least a nematic phase. The temperature range in which the nematic phase is exhibited is 40° C. or higher as described above.

The liquid crystal compound preferably does not include a polymerizable group in order to prevent a polymerization reaction. In addition, in order to prevent a decrease in the voltage holding ratio, the liquid crystal compound preferably does not include an ion component. Further, from the viewpoint of not making the response speed slow, the liquid crystal viscosity is preferably low, and thus the low-molecular-weight liquid crystal compound is preferable to the high-molecular-weight liquid crystal compound.

A content of the liquid crystal compound in the liquid crystal composition layer 20 is preferably 30% by mass or more and more preferably 50% by mass or more.

In the radio wave control element 10 according to the present invention, it is preferable that the liquid crystal composition layer 20 includes a dichroic substance in addition to the liquid crystal compound.

By including the dichroic substance in the liquid crystal composition layer 20, the Δn of the liquid crystal composition layer 20 in a case of suitably controlling the radio waves can be increased.

In the present invention, the dichroic substance is not particularly limited.

The dichroic substance is a substance exhibiting dichroism, and the dichroism denotes a property in which an absorbance varies depending on the polarization direction.

The dichroic substance is not particularly limited, and examples thereof include a visible light-absorbing substance (a dichroic dye), a luminescent substance (a fluorescent substance, a phosphorescent substance, or the like), an ultraviolet light-absorbing substance, an infrared light-absorbing substance, a nonlinear optical substance, a carbon nanotube, and an inorganic substance (for example, a quantum rod), and a conventionally known dichroic substance (a dichroic dye) can be used.

Specific examples thereof include those described in paragraphs 0067 to 0071 of JP2013-228706A, paragraphs 0008 to 0026 of JP2013-227532A, paragraphs 0008 to 0015 of JP2013-209367A, paragraphs 0045 to 0058 of JP2013-14883A, paragraphs 0012 to 0029 of JP2013-109090A, paragraphs 0009 to 0017 of JP2013-101328A, paragraphs 0051 to 0065 of JP2013-37353A, paragraphs 0049 to 0073 of JP2012-63387A, paragraphs 0016 to 0018 of JP1999-305036A (JP-H11-305036A), paragraphs 0009 to 0011 of JP2001-133630A, paragraphs 0030 to 0169 of JP2011-215337A, paragraphs 0021 to 0075 of JP2010-106242A, paragraphs 0011 to 0025 of JP2010-215846A, paragraphs 0017 to 0069 of JP2011-048311A, paragraphs 0013 to 0133 of JP2011-213610A, paragraphs 0074 to 0246 of JP2011-237513A, paragraphs 0005 to 0041 of WO2016/060173A, and paragraphs 0008 to 0062 of WO2016/136561A.

In addition, a liquid crystal substance is suitably used as the dichroic substance.

As the dichroic substance, a dichroic azo coloring agent compound is preferable.

The dichroic azo coloring agent compound means an azo coloring agent compound having different absorbances depending on directions. The dichroic azo coloring agent compound may or may not exhibit liquid crystallinity. In a case where the dichroic azo coloring agent compound exhibits liquid crystallinity, any of nematic properties or smectic properties may be exhibited.

A content of the dichroic substance in the liquid crystal composition layer 20 is not limited, but is preferably 30% by mass or more.

By setting the content of the dichroic substance in the liquid crystal composition layer 20 to 30% by mass or more, the Δn of the liquid crystal composition layer 20 in a case of suitably controlling the radio waves can be increased.

The content of the dichroic substance in the liquid crystal composition layer 20 is more preferably 40% by mass or more and still more preferably 50% by mass or more. In a case where the dichroic substance exhibits liquid crystallinity, the liquid crystal composition layer 20 may not include a liquid crystal compound other than the dichroic substance, and the content of the dichroic substance is still more preferably 80% by mass or more since the Δn can be increased by the dichroic substance.

Hereinbefore, the radio wave control element of the embodiment of the present invention has been described in detail, but the present invention is not limited to the above-described examples, and various improvements and changes may be made without departing from the spirit of the present invention.

For example, in the radio wave control element 10 according to the present invention shown in FIG. 1, the liquid crystal composition layer 20 is sandwiched between the supports 16 and 24, and the microstructures 14 (second electrode) and the first electrode layer 26 are provided on the surface of the support opposite to the liquid crystal composition layer 20, but the present invention is not limited thereto.

As an example, the radio wave control element according to the present invention may have a configuration in which the microstructures are two-dimensionally arranged and provided on two supports, and the liquid crystal composition layer is sandwiched between the two supports toward the microstructures, as described in B. Kang, et al, SID 2023 DIGEST (2023) p. 993.

In this configuration, a planar electrode layer may be provided on one support instead of the microstructures. Alternatively, both microstructures (electrodes) may face the liquid crystal composition layer, or one microstructure may face the liquid crystal composition layer and the other microstructure may be provided on the surface of the support opposite to the liquid crystal composition layer.

### EXAMPLES

Hereinafter, the present invention will be described in more detail with reference to Examples.

The materials, the amounts of materials used, the ratios, the treatment details, the treatment procedure, or the like shown in the following Examples can be appropriately modified without departing from the spirit of the present invention. Therefore, the scope of the present invention should not be restrictively interpreted by the following Examples.

### [Preparation of Liquid Crystal Composition]

### <Liquid Crystal Compound>

As the liquid crystal compound, the following compound 1 was prepared.

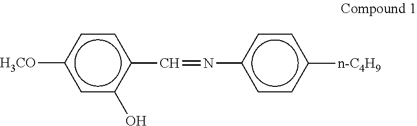

### <Dichroic Substance>

As the dichroic substance, the following compound 2-1 and compound 2-2 were prepared.

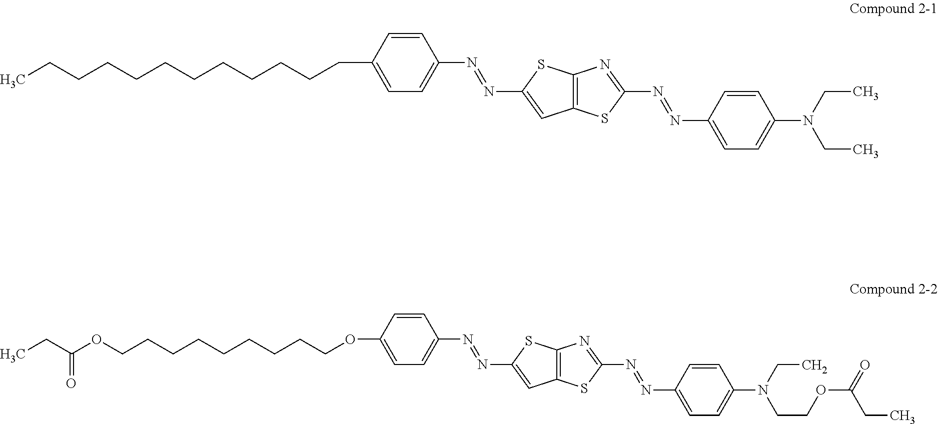

The above-described compound 1, compound 2-1, compound 2-2, and the liquid crystal compound A (manufactured by DIC Corporation, RDP-A3123) were mixed to have the composition shown in Table 1 described below to prepare liquid crystal compositions corresponding to Examples 1 to 5 and Comparative Example 1.

### <Measurement of Solid-Liquid Crystal Phase Transition Temperature>

The prepared liquid crystal composition was set on a hot stage. The liquid crystal composition set on the hot stage was observed with a polarizing microscope.

The liquid crystal composition was heated to a temperature at which the liquid crystal phase was formed, and then the temperature at which the liquid crystal phase was transitioned to a crystal (referred to as a solid-liquid crystal phase transition temperature) was examined while cooling the liquid crystal composition.

As a result, the solid-liquid crystal phase transition temperatures of the liquid crystal compositions corresponding to Examples 1 to 5 were all 40° C. or higher, and the solid-liquid crystal phase transition temperature of the liquid crystal composition (compound A: 100% by mass) corresponding to Comparative Example 1 was lower than 40° C. The results are also shown in Table 1.

### [Production of Liquid Crystal Composition Layer]

A polyimide resin (LX-1400, manufactured by Hitachi Chemical Co., Ltd.) was coated on a 3 cm square quartz glass substrate to a thickness of about 30 nm as an alignment film, and a rubbing treatment (rotation speed: 1000 rpm, moving speed: 20 mm/s, one round trip) was performed.

The liquid crystal composition was dissolved in a chloroform solvent such that the concentration of solid contents was 1% by mass, and the solution was cast on the alignment film to obtain a sample having a film thickness of 90 nm by spin coating.

The liquid crystal composition was heated to a temperature equal to or higher than the nematic transition temperature to form a nematic phase in which the liquid crystal composition was aligned, in the same temperature process as that actually used in radio wave control elements, and then cooled to room temperature to obtain aligned liquid crystal composition layers corresponding to Examples 1 to 5 and Comparative Example 1 (see Table 1).

### <Measurement of X-Ray Diffraction>

X-ray diffraction (XRD) of the produced liquid crystal composition layer was measured by the above-described method.

In the XRD spectrum, those in which a peak was observed at a diffraction angle of 15° or less were defined as A, and those in which a peak was not observed at a diffraction angle of 15° or less were defined as B.

### <Measurement of Alignment Degree>

The alignment degree of the produced liquid crystal composition layer was measured by the above-described method.

Those having an alignment degree higher than 0.85 were defined as A, and those having an alignment degree of 0.85 or less were defined as B.

<Measurement of Refractive Index Anisotropy (Δn)>

The refractive index anisotropy Δn of the produced liquid crystal composition layer at 30 GHz was measured by the method described in Applied Optics, Vol. 44, No. 7, p. 1150 (2005).

The liquid crystal composition was filled and arranged in a variable short-circuit waveguide to measure the refractive index anisotropy Δn. Radio waves of 30 GHz were input to the waveguide, and an amplitude ratio of a reflected wave to an incident wave was measured. The measurement was performed by changing the orientation of the static magnetic field and the tube length of the short-circuiting plate, and the refractive indices ne and no were determined. The refractive index anisotropy (Δn @ 30 GHz) was calculated from ne-no.

Those having a Δn of 0.40 or more were defined as A, those having a Δn of less than 0.40 and 0.25 or more were defined as B, those having a Δn of less than 0.25 and 0.20 or more were defined as C, and those having a Δn of less than 0.20 were defined as D.

The above results are shown in Table 1.

### [Production of Radio Wave Control Element]

Using the produced liquid crystal composition layer, the radio wave control elements of Examples 1 to 5 and Comparative Example 1 were produced by the method described in B. Kang, et al, SID 2023 DIGEST (2023) p. 993.

The radio wave control element has a metasurface structure in which circular microstructures are two-dimensionally arranged at equal intervals in the X-Y direction orthogonal to each other at equal intervals.

In addition, the radio wave control element has a configuration in which the microstructures are sandwiched between two supports on which the microstructures are formed on one surface, toward the liquid crystal composition layer. As the support, a glass plate was used.

Further, an alternating current power supply was connected to each of the microstructures constituting the electrode pair.

In the radio wave control element, the temperature control mechanism was provided to be in contact with the entire surface of one support. The temperature control mechanism used a Peltier element.

### <Evaluation of Alignment Retainability>

The produced radio wave control element was heated to a temperature of the liquid crystal phase transition temperature or higher of the liquid crystal composition layer by using the temperature control mechanism.

Next, an equal bias voltage was applied to each microstructure in a state of maintaining the temperature, and the alignment state of the liquid crystal compound was changed.

Thereafter, the temperature was cooled to room temperature (20° C.) while applying the driving voltage, and the power supply from the power supply was stopped to stop the application of the voltage to the liquid crystal composition layer.

In this case, at each stage of before heating to a temperature of the liquid crystal phase transition temperature or higher and applying the bias voltage, the state of applying the bias voltage, and after cooling and stopping the application of the bias voltage, the reflected radio waves from the radio wave control element were measured by a horn antenna connected to a network analyzer by the method described in B. Kang, et al, SID 2023 DIGEST (2023) p. 994.

From the measured reflected radio waves, those in which the reflected radio wave characteristics after cooling and stopping the application of the voltage were maintained as the reflected radio wave characteristics in a state of applying the voltage, that is, those in which the alignment state of the liquid crystal compound was retained were defined as A, and those in which the reflected radio wave characteristics in a state of applying the voltage were not maintained, that is, those in which the alignment state of the liquid crystal compound was relaxed were defined as B.

The results are shown in Table 1 below.

TABLE 1

| | Liquid crystal | | Liquid crystal | | | | |
|---|---|---|---|---|---|---|---|
| | composition/content | | phase | | | | |
| | First | Second | transition | X-ray | Alignment | | Alignment |
| | component | component | temperature | diffraction | degree | Δn | retainability |
| Example 1 | Compound 1 | — | 40° C. or higher | B | B | D | A |
| | 100% by mass | | | | | | |
| | or more | | | | | | |
| Example 2 | Compound 1 | Compound 2-1 | 40° C. or higher | B | B | C | A |
| | 90% by mass | 10% by mass | | | | | |
| | or more | or more | | | | | |
| Example 3 | Compound 1 | Compound 2-2 | 40° C. or higher | A | A | C | A |
| | 90% by mass | 10% by mass | | | | | |
| | or more | or more | | | | | |
| Example 4 | Compound 1 | Compound 2-2 | 40° C. or higher | A | A | B | A |
| | 70% by mass | 30% by mass | | | | | |
| | or more | or more | | | | | |
| Example 5 | Compound 2-2 | | 40° C. or higher | A | A | A | A |
| | 100% by mass | | | | | | |
| | or more | | | | | | |
| Comparative | Compound A | — | lower than | B | B | C | B |
| Example 1 | 100% by mass | | 40° C. | | | | |
| | or more | | | | | | |

As shown in Table 1, with the radio wave control element according to the present invention in which the liquid crystal phase transition temperature of the liquid crystal composition layer is 40° C. or higher, the alignment state of the liquid crystal compound in the liquid crystal composition layer can be maintained even after the liquid crystal composition layer is heated, the voltage is applied to align the liquid crystal compound, and the application of the voltage is stopped by cooling.

That is, with the radio wave control element according to the present invention, the traveling direction of the radio waves can be controlled in a desired direction even after the liquid crystal compound is aligned by heating and applying the voltage, and the voltage is not applied after cooling. Therefore, with the radio wave control element according to the present invention, the power consumption required for controlling the radio waves can be reduced.

### <Evaluation of Frequency Variability (Tunability)>

The produced radio wave control element was heated to a temperature of the liquid crystal phase transition temperature or higher of the liquid crystal composition layer by using the temperature control mechanism.

Next, an equal bias voltage was applied to each microstructure in a state of maintaining the temperature, and the alignment state of the liquid crystal compound was changed.

Thereafter, the temperature was cooled to room temperature (20° C.) while applying the driving voltage, and the power supply from the power supply was stopped to stop the application of the voltage to the liquid crystal composition layer.

This operation was performed by changing the bias voltage to 0 to 25 V, and the frequency variability (tunability) was measured for each radio wave control element by a horn antenna connected to a network analyzer by the method described in B. Kang, et al, SID 2023 DIGEST (2023) p. 994.

As a result, the radio wave control element of Example 5 had the highest frequency variability, the radio wave control element of Example 4 had the second highest frequency variability, the radio wave control elements of Examples 2 and 3 had the third highest frequency variability, and the radio wave control element of Example 1 had the lowest frequency variability. The difference between Examples 2 and 3 was small, but Example 3 was higher.

From this result, it can be seen that the larger the Δn is, the higher the frequency variability of the radio wave control element is, that is, the wider the range of possible characteristic changes is. As the frequency variability is higher, the frequency range of the radio waves corresponding to the radio wave control element is wider. In addition, as the frequency variability is higher, the movable phase range is wider, so that the range of angles to be reflected can also be wider.

The radio wave control element can be suitably used in an active antenna, a beam steering device, and the like in radio wave communication and the like.

### EXPLANATION OF REFERENCES

10: radio wave control element
12: metasurface structure
14: microstructure
16, 24: support
20: liquid crystal composition layer
26: first electrode layer
28: power supply
30: temperature control mechanism
LC: liquid crystal compound
ANT: antenna
AR1, AR2: area
BL: building
RD: radio wave reflecting device
RW: radio wave

What is claimed is:

1. A radio wave control element comprising, in the following order:
a first electrode;
a liquid crystal composition layer; and
a second electrode,
wherein at least one of the first electrode or the second electrode has a metasurface structure in which a plurality of microstructures are arranged,
the radio wave control element further includes a temperature control mechanism that heats and cools the liquid crystal composition layer, and
a solid-liquid crystal phase transition temperature of the liquid crystal composition layer is 40° C. or higher.

2. The radio wave control element according to claim 1,
wherein the liquid crystal composition layer, in an X-ray diffraction spectrum measured at a temperature lower than 40° C., is capable of having a peak in a range in which a diffraction angle is 15° or less.

3. The radio wave control element according to claim 1,
wherein the liquid crystal composition layer contains a dichroic substance.

4. The radio wave control element according to claim 3,
wherein a content of the dichroic substance is 30% by mass or more with respect to a total mass of the liquid crystal composition layer.

5. The radio wave control element according to claim 2,
wherein the liquid crystal composition layer contains a dichroic substance.

6. The radio wave control element according to claim 5,
wherein a content of the dichroic substance is 30% by mass or more with respect to a total mass of the liquid crystal composition layer.
